(19) United States
(12) Patent Application Publication
(10) Pub. No.: US 2025/0200798 A1
(43) Pub. Date: Jun. 19, 2025

(54) POSITIONING METHOD AND APPARATUS, AND ELECTRONIC DEVICE

(71) Applicant: Beijing Zitiao Network Technology Co., Ltd., Beijing (CN)

(72) Inventors: Meixia LIN, Beijing (CN); Hengkai GUO, Beijing (CN); Sheng ZHANG, Beijing (CN)

(21) Appl. No.: 18/849,473

(22) PCT Filed: Mar. 20, 2023
(86) PCT No.: PCT/CN2023/082437

§ 371 Date: Sep. 20, 2024

(30) Foreign Application Priority Data
Mar. 22, 2022 (CN) 202210283396.X

(51) Int. Cl. G06T 7/73

(52) U.S. Cl. CPC G06T 7/74

(57) ABSTRACT

Embodiments of the present disclosure provide a positioning method and apparatus, and an electronic device, and the positioning method includes: acquiring a fusion pose of a query frame from a terminal; acquiring, based on the fusion pose of the query frame, a plurality of candidate pictures from a cloud database, a spatial distance and an angle between each of the plurality of candidate pictures and the query frame meeting a preset condition; determining, from the plurality of candidate pictures, a top specified number of candidate pictures each having a minimum spatial distance from the query frame as a recall frame; and determining, based on a matching relationship between feature points of the recall frame and feature points of the query frame, a pose of the query frame to perform positioning according to the pose of the query frame.

The present application claims the priority to Chinese Patent Application No. 202210283396.X, filed on Mar. 22, 2022, the entire disclosure of which is incorporated herein by reference as portion of the present application.

### TECHNICAL FIELD

Embodiments of the present disclosure relate to a positioning method and apparatus, and an electronic device.

### BACKGROUND

Visual positioning is a technology that generally utilizes scenario similarity to screen a certain number of frames that are similar to the scenario of current frame from a large number of pictures in a cloud database, then screens out the recall frames with a pose provided by GPS or fusion (the pose has a small gap with the current frame) to leave frames that satisfy the distance and scenario similarity, and finally uses the left frames that satisfy the distance and scenario similarity to perform pose calculation for positioning.

However, due to the large order of magnitude of pictures in the cloud database, this massive screening method is time-consuming and ineffective, and the frames recalled by means of scenario similarity alone are not ideal in the case of a great change of illumination or a great difference of viewing angle.

### SUMMARY

Embodiments of the present disclosure provide a positioning method and apparatus, and an electronic device, for improving the efficiency and accuracy of visual positioning.

In a first aspect, the embodiments of the present disclosure provide a positioning method, including:
acquiring a fusion pose of a query frame from a terminal;
acquiring, based on the fusion pose of the query frame, a plurality of candidate pictures from a cloud database, a spatial distance and an angle between each of the plurality of candidate pictures and the query frame meeting a preset condition;
determining, from the plurality of candidate pictures, a top specified number of candidate pictures each having a minimum spatial distance from the query frame as a recall frame; and
determining, based on a matching relationship between feature points of the recall frame and feature points of the query frame, a pose of the query frame to perform positioning according to the pose of the query frame.

In a second aspect, the embodiments of the present disclosure provide a positioning apparatus, including:
a first acquisition module, configured to acquire a fusion pose of a query frame from a terminal;
a second acquisition module, configured to acquire, based on the fusion pose of the query frame, a plurality of candidate pictures from a cloud database, in which a spatial distance and an angle between each of the plurality of candidate pictures and the query frame meet a preset condition;
a first determination module, configured to determine, from the plurality of candidate pictures, a top specified number of candidate pictures each having a minimum spatial distance from the query frame as a recall frame; and
a second determination module, configured to determine, based on a matching relationship between feature points of the recall frame and feature points of the query frame, a pose of the query frame to perform positioning according to the pose of the query frame.

In a third aspect, the embodiments of the present disclosure provide an electronic device, including:
a processor; and
a memory, storing computer-executable instructions, in which the executable instructions, when executed, enable the processor to perform the following operations:
acquiring a fusion pose of a query frame from a terminal;
acquiring, based on the fusion pose of the query frame, a plurality of candidate pictures from a cloud database, a spatial distance and an angle between each of the plurality of candidate pictures and the query frame meeting a preset condition;
determining, from the plurality of candidate pictures, a top specified number of candidate pictures each having a minimum spatial distance from the query frame as a recall frame; and
determining, based on a matching relationship between feature points of the recall frame and feature points of the query frame, a pose of the query frame to perform positioning according to the pose of the query frame.

In a fourth aspect, the embodiments of the present disclosure provide a computer-readable storage medium, which stores one or more programs, and the one or more programs, when executed by an electronic device including at least one application program, enable the electronic device to perform the following operations:
acquiring a fusion pose of a query frame from a terminal;
acquiring, based on the fusion pose of the query frame, a plurality of candidate pictures from a cloud database, a spatial distance and an angle between each of the plurality of candidate pictures and the query frame meeting a preset condition;
determining, from the plurality of candidate pictures, a top specified number of candidate pictures each having a minimum spatial distance from the query frame as a recall frame; and
determining, based on a matching relationship between feature points of the recall frame and feature points of the query frame, a pose of the query frame to perform positioning according to the pose of the query frame

According to one or more embodiments of the present disclosure, the fusion pose of the query frame from the terminal is used as a predicted pose for preliminary screening of pictures in the cloud database, the candidate pictures each having the distance and angle satisfying the preset condition are screened from these pictures, the top specified number of candidate pictures having the minimum distance are selected from the candidate pictures as the recall frame, which reduces the workload of massive screening, and then, the current pose of the query frame is determined using the matching relationship between the feature points of the recall frame and the feature points of the query frame, to perform positioning according to the current pose. Moreover, the situation in which the query frame is similar to the recall frame only in terms of scenario but the pose has a great difference may also be filtered out, thus improving the accuracy of visual positioning.

### BRIEF DESCRIPTION OF DRAWINGS

In order to more clearly illustrate one or more embodiments of the present disclosure, the drawings to be used in the description of the embodiments will be briefly described below. Obviously, the drawings in the following description are only some embodiments recorded in the present disclosure. For those ordinarily skilled in the art, other drawings may be obtained based on these drawings without inventive work.

FIG. 1 is a schematic flowchart of an implementation of a positioning method according to an embodiment of the present disclosure;

FIG. 2 is a schematic structural diagram of a positioning apparatus according to an embodiment of the present disclosure; and

FIG. 3 is a schematic structural diagram of an electronic device according to an embodiment of the present disclosure.

### DETAILED DESCRIPTION

In order to make the objects, technical solutions, and advantages of the present disclosure more apparent, the following will detail the example embodiments according to the present disclosure with reference to the drawings. Apparently, the described embodiments are only a part but not all of the embodiments of the present disclosure. It should be understood that the present disclosure is not limited to the example embodiments described here.

The embodiments of the present disclosure will be described in more detail below with reference to the drawings. While certain embodiments of the present disclosure are shown in the drawings, it should be understood that the present disclosure may be embodied in various forms and should not be construed as limited to the embodiments set forth herein. Rather, these embodiments are provided for a thorough and complete understanding of the present disclosure. It should be understood that the drawings and embodiments of the present disclosure are only for exemplary purposes and are not intended to limit the protection scope of the present disclosure.

It should be understood that the various steps described in the method embodiments of the present disclosure may be performed in different orders and/or in parallel. Furthermore, the method embodiments may include additional steps and/or omit performing the illustrated steps. The protection scope of the present disclosure is not limited in this aspect.

As used herein, the term “include,” “comprise,” and variations thereof are open-ended inclusions, i.e., “including but not limited to.” The term “based on” is “based, at least in part, on.” The term “an embodiment” represents “at least one embodiment,” the term “another embodiment” represents “at least one additional embodiment,” and the term “some embodiments” represents “at least some embodiments.” Relevant definitions of other terms will be given in the description below.

It should be noted that concepts such as the “first,” “second,” or the like mentioned in the present disclosure are only used to distinguish different devices, modules or units, and are not used to limit the interdependence relationship or the order of functions performed by these devices, modules or units.

It should be noted that the modifications of “a,” “an,” “a plurality of,” or the like mentioned in the present disclosure are illustrative rather than restrictive, and those skilled in the art should understand that unless the context clearly indicates otherwise, these modifications should be understood as “one or more.”

The names of the messages or information exchanged between a plurality of apparatuses in the embodiments of the present disclosure are for illustrative purposes only and are not intended to limit the scope of these messages or information.

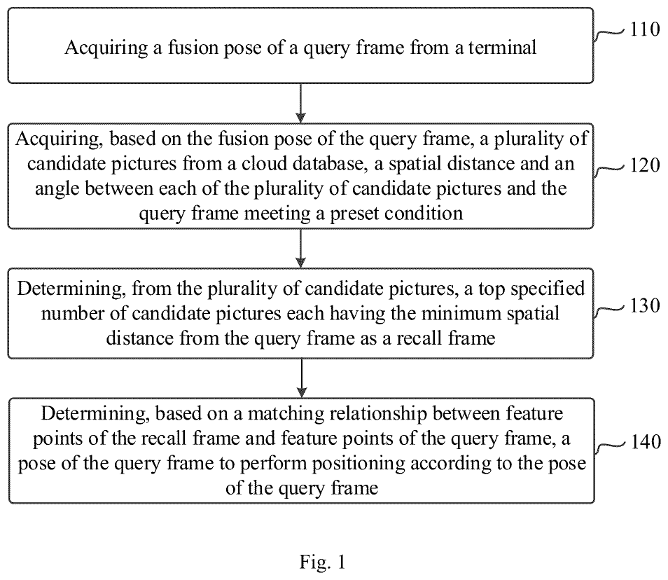

With reference to FIG. 1, FIG. 1 is a schematic flowchart of a positioning method according to an embodiment of the present disclosure. As shown in FIG. 1, the flowchart includes the following steps.

Step 110: acquiring a fusion pose of a query frame from a terminal.

The query frame is a picture frame sent to the cloud by the terminal, involving information such as GPS of the picture frame. The picture frame is used for acquiring a pose corresponding thereto so that visual positioning may be performed based on the pose.

Optionally, in order to reduce the workload of visual positioning based on the query frame from the terminal and improve the efficiency of visual positioning, according to the embodiments of the present disclosure, the fusion pose of the query frame from the terminal may be acquired first, and then used as a predicted pose, i.e., to predict the currently possible actual pose of the query frame. Specifically, acquiring the fusion pose of the query frame from the terminal includes:
acquiring a local pose of the query frame on the terminal and a global pose of the query frame on the cloud, from the terminal; and
determining the fusion pose of the query frame based on the local pose of the query frame on the terminal and the global pose of the query frame on the cloud.

The local pose of the query frame on the terminal is a pose coordinate of the query frame in a local coordinate system where the terminal is located. The global pose of the query frame on the cloud is a pose coordinate of the query frame in a global coordinate system where the cloud is located.

In practical applications, cell phones installed with different types of operating systems have different pose fusion solutions. Taking a cell phone installed with IOS as an example, determining the fusion pose of the query frame based on the local pose of the query frame on the terminal and the global pose of the query frame on the cloud may specifically include: based on the pose coordinate of the query frame in the local coordinate system where the terminal is located and the pose coordinate of the query frame in the global coordinate system where the cloud is located, determining a transformation relationship between the pose coordinate of the query frame in the local coordinate system and the pose coordinate of the query frame in the global coordinate system; and then based on the transformation relationship, transforming the pose coordinate of the query frame in the local coordinate system where the terminal is located to the pose coordinate in the global coordinate system. Assuming that there are 10 query frames, after the transformation relationship between the pose coordinate of the query frame in the local coordinate system where the terminal is located and the pose coordinate of the query frame in the global coordinate system where the cloud is located is determined, local poses of the 10 query frames are transformed to global poses one by one in accordance with the transformation relationship, so as to obtain the fusion pose.

Taking a cell phone installed with an Android operating system as an example, determining the fusion pose of the query frame based on the local pose of the query frame on the terminal and the global pose of the query frame on the cloud may specifically include: performing optimization based on a constraint relationship between an interior point of the local pose of the query frame on the terminal and a corresponding 3D point, and a constraint relationship between an interior point of the global pose of the query frame on the cloud and a corresponding 3D point, to obtain the fusion pose of the query frame. The constraint relationship between the interior point of the local pose of the query frame on the terminal and the corresponding 3D point is that the 3D point corresponding to the interior point of the local pose of the query frame on the terminal is projected onto an image plane through a camera model, and a pixel distance between the projected point and the interior point is calculated, thus constituting a residual of the constraint relationship. The constraint relationship between the interior point of the global pose of the query frame on the cloud and the corresponding 3D point is that the 3D point corresponding to the interior point of the global pose of the query frame on the cloud is projected onto an image plane through a camera model, and a pixel distance between the projected point and the interior point is calculated, thus constituting the residual of the constraint relationship.

Step 120: acquiring, based on the fusion pose of the query frame, a plurality of candidate pictures from a cloud database, a spatial distance and an angle between each of the plurality of candidate pictures and the query frame meeting a preset condition.

For example, an off-line captured map is saved in the cloud database, and the map may be divided into a plurality of pictures of a large order of magnitude to be saved in the cloud database.

Optionally, when a camera of the terminal is capturing the query frame, there may be a dynamic object in front of the camera (in this case, the correlation between the pose on the terminal and the pose on the cloud will be wrong), a dramatic change of image illumination (in this case, the optical flow tracking is poor, resulting in an error in the pose calculation), or a sudden all-black (which also results in an error in the pose calculation), and other situations, which will result in an error in the calculation of the fusion pose of the query frame. Therefore, in order to improve the validity of visual positioning, the validity of the fusion pose of the query frame may be judged first. Specifically, acquiring, based on the fusion pose of the query frame, the plurality of candidate pictures from the cloud database, a spatial distance and an angle between each of the plurality of candidate pictures and the query frame meeting the preset condition, includes:
determining validity of the fusion pose of the query frame based on a calculation result of the fusion pose of the query frame; and
if the fusion pose of the query frame is valid, acquiring, based on the fusion pose of the query frame, from the cloud database, the plurality of candidate pictures from the cloud database, a spatial distance and an angle between each of the plurality of candidate pictures and the query frame meeting the preset condition.

The validity of the fusion pose of the query frame is based on whether the pose on the terminal and the pose on the cloud are correlated and corresponding to each other, and pose error at either the terminal and the cloud may cause the corresponding fusion pose to be invalidated. Generally speaking, the error probability of the pose in the cloud is small, and it is usually only necessary to determine whether the pose in the terminal is wrong or not.

Optionally, in order to improve the efficiency of visual positioning and reduce the matching workload directly based on the query frame and the pictures in the cloud database, the pictures in the cloud database may be subjected to preliminary screening based on the fusion pose of the query frame in advance, to determine some pictures that are closer to the actual pose of the query frame. Specifically, acquiring, based on the fusion pose of the query frame, the plurality of candidate pictures from the cloud database, a spatial distance and an angle between each of the plurality of candidate pictures and the query frame meeting the preset condition, includes:
determining, in the cloud database, a plurality of pictures each having a spatial distance from the fusion pose less than or equal to a first preset distance threshold; and
acquiring the plurality of candidate pictures from the plurality of pictures, a spatial distance and an angle between each of the plurality of candidate pictures and the query frame meeting the preset condition.

As an example, acquiring the plurality of candidate pictures from the plurality of pictures, a spatial distance and an angle between each of the plurality of candidate pictures and the query frame meeting the preset condition, may include: pictures each having a spatial distance greater than 40 meters from the query frame, and pictures each having an angle greater than 120 degrees from the query frame may be filtered out from the plurality of pictures, and the remaining pictures may be used as the candidate pictures. The angle between a candidate picture and the query frame may be determined according to an absolute angle between the candidate picture and the query frame.

Step 130: determining, from the plurality of candidate pictures, a top specified number of candidate pictures each having the minimum spatial distance from the query frame as a recall frame.

Optionally, in order to more accurately determine the current pose of the query frame, determining, from the plurality of candidate pictures, a top specified number of candidate pictures each having the minimum spatial distance from the query frame as a recall frame, includes:
sorting the plurality of candidate pictures in an order of spatial distances between the plurality of candidate pictures and the query frame from minimum to maximum; and
determining, from the plurality of candidate pictures after the sorting, a top specified number of candidate pictures each having the minimum spatial distance from the query frame as the recall frame.

As an example, from the plurality of candidate pictures after the sorting, the top (first) 10 candidate pictures each having the minimum spatial distance from the query frame may be determined as the recall frame.

Step 140: determining, based on a matching relationship between feature points of the recall frame and feature points of the query frame, a pose of the query frame to perform positioning according to the pose of the query frame.

As an example, a gray value of a pixel of a point may be compared with gray values of other pixels around the point, if a sufficient number of points around the point have gray values that are sufficiently different from the gray value of the point, then the point is considered to be a feature point.

Optionally, in order to save the time of positioning and to improve the accuracy of positioning, the specified number of feature points of the recall frame may be projected onto the query frame, and a projection range may be defined to narrow the search range, to avoid, for example, a false matching caused by the fact that the upper left corner and the lower right corner are only similar in texture but have large difference in pixel distance. Specifically, determining, based on the matching relationship between feature points of the recall frame and feature points of the query frame, the pose of the query frame to perform positioning according to the pose of the query frame, includes:
projecting the specified number of feature points of the recall frame onto the query frame, to determine a matching relationship between the specified number of feature points of the recall frame and the feature points of the query frame within a preset range of projection; and
determining, based on the matching relationship between the feature points of the recall frame and the feature points of the query frame, the pose of the query frame to perform positioning according to the pose of the query frame.

As an example, projecting the specified number of feature points of the recall frame onto the query frame, to determine the matching relationship between the specified number of feature points of the recall frame and the feature points of the query frame within a preset range of projection may specifically include: taking the pixel position projected by the camera model onto the query frame as a center point of projection, and taking seven pixels as a projection radius to define a projection range.

Optionally, determining, based on the matching relationship between feature points of the recall frame and feature points of the query frame, the pose of the query frame to perform positioning according to the pose of the query frame, includes:
determining feature points matched between the recall frame and the query frame, based on the matching relationship between the feature points of the recall frame and the feature points of the query frame;
determining three-dimensional (3D) points on a map corresponding to the feature points matched between the recall frame and the query frame, in which feature points in the recall frame have a mapping relationship with the 3D points on the map; and
determining, based on the 3D points on the map corresponding to the feature points matched between the recall frame and the query frame, the pose of the query frame to perform positioning according to the pose of the query frame.

Optionally, the feature points matched between the recall frame and the query frame may be determined based on the similarity between descriptors of the feature points of the recall frame and descriptors of the feature points of the query frame. The descriptor of a feature point may be used to characterize a specificity of the feature point, specifically, the peripheral outline of the feature point. The descriptor of a feature point may be expressed as a vector. Assuming that the vector of the descriptor of the feature point is of 128 dimensions, the 128 dimensions are compared one by one with 128 dimensions of the recall frame, and +1 if there is a matching. Assuming that there are 50 values of the descriptor similarity of the matched feature points, then, 50 is taken as a value of the descriptor similarity of two feature points, and the higher the value of the descriptor similarity, the higher the similarity between two feature points. For example, if the value of the descriptor similarity reaches a certain value, it indicates that the matching is successful.

Assuming that there are 10 matched feature points between the query frame and the recall frame, the current pose of the query frame may be calculated based on these 10 matched feature points. The specific calculation refers to calculating the pose of the query frame according to the correlation relationship between the corresponding 3D points on the map for each feature point of the recall frame, to perform visual positioning according to the pose of the query frame.

According to the positioning method provided by the embodiments of the present disclosure, the fusion pose of the query frame from the terminal is used as a predicted pose for preliminary screening of pictures in the cloud database, the candidate pictures each having the distance and angle satisfying the preset condition are screened from these pictures, the top specified number of candidate pictures having the minimum distance are selected from the candidate pictures as the recall frame, which reduces the workload of massive screening, and then, the current pose of the query frame is determined using the matching relationship between the feature points of the recall frame and the feature points of the query frame, to perform positioning according to the current pose. Moreover, the situation in which the query frame is similar to the recall frame only in terms of scenario but the pose has a great difference may also be filtered out, thus improving the accuracy of visual positioning.

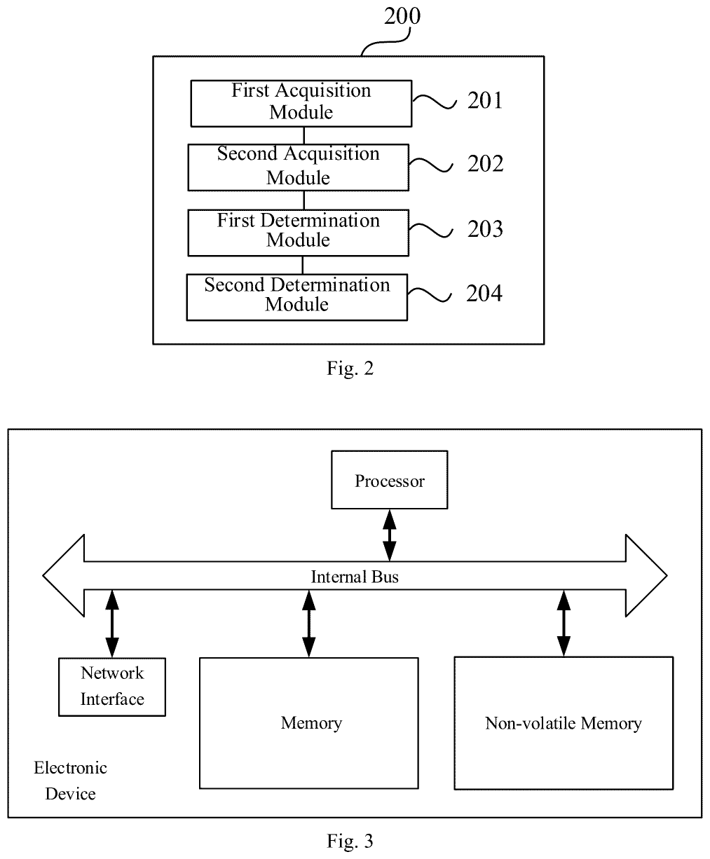

FIG. 2 is a schematic structural diagram of a positioning apparatus 200 according to an embodiment of the present disclosure. With reference to FIG. 2, in a software implementation, the positioning apparatus 200 may include:
a first acquisition module 201, configured to acquire a fusion pose of a query frame from a terminal;
a second acquisition module 202, configured to acquire, based on the fusion pose of the query frame, a plurality of candidate pictures from a cloud database, in which a spatial distance and an angle between each of the plurality of candidate pictures and the query frame meet a preset condition;
a first determination module 203, configured to determine, from the plurality of candidate pictures, a top specified number of candidate pictures each having the minimum spatial distance from the query frame as a recall frame; and
a second determination module 204, configured to determine, based on a matching relationship between feature points of the recall frame and feature points of the query frame, a pose of the query frame to perform positioning according to the pose of the query frame.

According to the positioning apparatus provided by the embodiments of the present disclosure, the fusion pose of the query frame from the terminal is used as a predicted pose for preliminary screening of pictures in the cloud database, the candidate pictures each having the distance and angle satisfying the preset condition are screened from these pictures, the top specified number of candidate pictures having the minimum distance are selected from the candidate pictures as the recall frame, which reduces the workload of massive screening, and then, the current pose of the query frame is determined using the matching relationship between the feature points of the recall frame and the feature points of the query frame, to perform positioning according to the current pose. Moreover, the situation in which the query frame is similar to the recall frame only in terms of scenario but the pose has a great difference may also be filtered out, thus improving the accuracy of visual positioning.

Optionally, in an implementation, the second acquisition module 202 is configured to:
determine validity of the fusion pose of the query frame based on a calculation result of the fusion pose of the query frame; and
if the fusion pose of the query frame is valid, acquire, based on the fusion pose of the query frame, from the cloud database, the plurality of candidate pictures from the cloud database, a spatial distance and an angle between each of the plurality of candidate pictures and the query frame meeting the preset condition.

Optionally, in an implementation, the second acquisition module 202 is configured to:
determine, in the cloud database, a plurality of pictures each having a spatial distance from the fusion pose less than or equal to a first preset distance threshold; and
acquire the plurality of candidate pictures from the plurality of pictures, in which a spatial distance and an angle between each of the plurality of candidate pictures and the query frame meet the preset condition.

Optionally, in an implementation, the first determination module 203 is configured to:
sort the plurality of candidate pictures in an order of spatial distances between the plurality of candidate pictures and the query frame from minimum to maximum; and
determine, from the plurality of candidate pictures after being sorted, a top specified number of candidate pictures each having the minimum spatial distance from the query frame as the recall frame.

Optionally, in an implementation, the second determination module 204 is configured to:
project the specified number of feature points of the recall frame onto the query frame, to determine a matching relationship between the specified number of feature points of the recall frame and the feature points of the query frame within a preset range of projection; and
determine, based on the matching relationship between the feature points of the recall frame and the feature points of the query frame, the pose of the query frame to perform positioning according to the pose of the query frame.

Optionally, in an implementation, the second determination module 204 is configured to:
determine feature points matched between the recall frame and the query frame, based on the matching relationship between the feature points of the recall frame and the feature points of the query frame;
determine 3D points on a map corresponding to the feature points matched between the recall frame and the query frame, wherein feature points in the recall frame have a mapping relationship with the 3D points on the map; and
determine, based on the 3D points on the map corresponding to the feature points matched between the recall frame and the query frame, the pose of the query frame to perform positioning according to the pose of the query frame.

Optionally, in an implementation, the first acquisition module 201 is configured to:
determine the fusion pose of the query frame based on the local pose of the query frame on the terminal and the global pose of the query frame on the cloud.

The positioning apparatus 200 is capable of implementing the method of the method embodiment in FIG. 1, with specific reference to the positioning method of the embodiment shown in FIG. 1, which will not be repeated.

FIG. 3 is a schematic structural diagram of an electronic device according to an embodiment of the present disclosure. Referring to FIG. 3, at the hardware level, the electronic device includes a processor and optionally includes an internal bus, a network interface, and a memory. The memory may include an internal memory, such as a high-speed random-access memory (RAM), and may further include a non-volatile memory, such as at least one disk memory. Of course, the electronic device may further include other hardware required for business.

The processor, the network interface and the memory may be connected to each other via the internal bus. The internal bus may be an ISA (Industry Standard Architecture) bus, a PCI (Peripheral Component Interconnect) bus or an EISA (Extended Industry Standard Architecture) bus. The bus may be categorized as an address bus, a data bus, a control bus, etc. For ease of representation, only one bidirectional arrow is shown in FIG. 3, but this does not mean that there is only one bus or one type of bus.

The memory is configured to store a program. Specifically, the program may include program code, and the program code includes computer operation instructions. The memory may include an internal memory and a non-volatile memory, and provide instructions and data to the processor.

The processor reads a corresponding computer program from the non-volatile memory into the internal memory and then runs the computer program, forming a positioning apparatus at the logical level. The processor executes the program stored in the memory and is specifically configured to perform the following operations:
acquiring a fusion pose of a query frame from a terminal;
acquiring, based on the fusion pose of the query frame, a plurality of candidate pictures from a cloud database, a spatial distance and an angle between each of the plurality of candidate pictures and the query frame meeting a preset condition;
determining, from the plurality of candidate pictures, a top specified number of candidate pictures each having a minimum spatial distance from the query frame as a recall frame; and
determining, based on a matching relationship between feature points of the recall frame and feature points of the query frame, a pose of the query frame to perform positioning according to the pose of the query frame.

According to the electronic device provided by the embodiments of the present disclosure, the fusion pose of the query frame from the terminal is used as a predicted pose for preliminary screening of pictures in the cloud database, the candidate pictures each having the distance and angle satisfying the preset condition are screened from these pictures, the top specified number of candidate pictures having the minimum distance are selected from the candidate pictures as the recall frame, which reduces the workload of massive screening, and then, the current pose of the query frame is determined using the matching relationship between the feature points of the recall frame and the feature points of the query frame, to perform positioning according to the current pose. Moreover, the situation in which the query frame is similar to the recall frame only in terms of scenario but the pose has a great difference may also be filtered out, thus improving the accuracy of visual positioning.

The method performed by the positioning apparatus disclosed in the embodiment of the present disclosure as shown in FIG. 1 may be applied in, or implemented by, a processor. The processor may be an integrated circuit chip and has a signal processing capability. In an implementation process, steps in the foregoing methods may be implemented by using a hardware integrated logical circuit in the processor, or by using instructions in a form of software. The processor may be a general-purpose processor, including a central processing unit (CPU), a network processor (NP), or the like, and the processor may also be a digital signal processor (DSP), an application specific integrated circuit (ASIC), a field-programmable gate array (FPGA) or other programmable logic device, discrete gate or transistor logic device, or a discrete hardware component. The processor can implement or execute the methods, steps, and logical block diagrams disclosed in the embodiments of the present disclosure. The general-purpose processor may be a microprocessor, or the processor may be any conventional processor or the like. The steps of the method disclosed with reference to the embodiments of the present disclosure may be directly executed and completed by a hardware decoding processor, or executed and completed by a combination of hardware and software modules in a decoding processor. The software modules may be in a storage medium mature in the art, such as a random-access memory, a flash memory, a read-only memory, a programmable read-only memory, an electrically erasable programmable memory, or a register. The storage medium is in the memory, and the processor reads information in the memory and completes the steps in the foregoing methods in combination with hardware of the processor.

The electronic device may also perform the method in FIG. 1 and implement the functions of the positioning apparatus in the embodiment shown in FIG. 1, which will not be repeated here in the embodiments of the present disclosure.

The embodiments of the present disclosure further provide a computer-readable storage medium that stores one or more programs. The one or more programs include instructions. When the instructions are executed by a portable electronic device including a plurality of applications, the portable electronic device is enabled to perform the method of the embodiment shown in FIG. 1, and is specifically configured to perform the following operations:
acquiring a fusion pose of a query frame from a terminal;
acquiring, based on the fusion pose of the query frame, a plurality of candidate pictures from a cloud database, a spatial distance and an angle between each of the plurality of candidate pictures and the query frame meeting a preset condition;
determining, from the plurality of candidate pictures, a top specified number of candidate pictures each having a minimum spatial distance from the query frame as a recall frame; and
determining, based on a matching relationship between feature points of the recall frame and feature points of the query frame, a pose of the query frame to perform positioning according to the pose of the query frame.

According to the computer-readable storage medium provided by the embodiments of the present disclosure, the fusion pose of the query frame from the terminal is used as a predicted pose for preliminary screening of pictures in the cloud database, the candidate pictures each having the distance and angle satisfying the preset condition are screened from these pictures, the top specified number of candidate pictures having the minimum distance are selected from the candidate pictures as the recall frame, which reduces the workload of massive screening, and then, the current pose of the query frame is determined using the matching relationship between the feature points of the recall frame and the feature points of the query frame, to perform positioning according to the current pose. Moreover, the situation in which the query frame is similar to the recall frame only in terms of scenario but the pose has a great difference may also be filtered out, thus improving the accuracy of visual positioning.

Of course, in addition to the software implementation, the electronic device of the present disclosure may be implemented in other manners, such as logic devices or a combination of hardware and software, that is, the execution body of the following processing process is not limited to each logic unit, but may also be hardware or a logic device.

The foregoing describes particular embodiments of the present disclosure. Other embodiments are within the scope of the appended claims. In some cases, the actions or steps documented in the claims may be performed in a different order than in the embodiments and still achieve the desired results. Moreover, the processes depicted in the drawings do not necessarily have to be performed in the particular order or consecutive order shown in order to achieve the desired results. In some embodiments, multitasking and parallel processing is also possible or may be advantageous.

In short, the above descriptions are merely preferred embodiments of the present disclosure, and are not intended to limit the protection scope of the present disclosure. Any modification, equivalent replacement, improvement or the like made within the spirit and principle of the present disclosure shall fall within the protection scope of the present disclosure.

The systems, apparatuses, modules, or units explained in the foregoing embodiments may be specifically implemented by a computer chip or entity, or implemented by a product having a particular function. An example implementation device is a computer. Specifically, the computer may be, for example, a personal computer, a laptop computer, a cell phone, a camera phone, a smartphone, a personal digital assistant, a media player, a navigation device, an email device, a game console, a tablet computer, a wearable device, or any combination of these devices.

Computer-readable media include permanent and non-permanent, removable and non-removable media, and information storage may be implemented by any method or technology. The information may be computer-readable instructions, a data structure, a program module, or other data. Examples of the storage media for computers include, but are not limited to, a phase-change random-access memory (PRAM), a static random-access memory (SRAM), a dynamic random-access memory (DRAM), another type of random-access memory (RAM), a read-only memory (ROM), an electrically erasable programmable read-only memory (EEPROM), a flash memory or other memory technology, a compact disc read-only memory (CD-ROM), a digital versatile disk (DVD) or other optical storage, a magnetic cartridge tape, disk storage or other magnetic storage devices or any other non-transitory medium, which may be used to store information that may be accessed by the computing device. As defined in the present disclosure, the computer-readable medium does not include transitory computer-readable medium (transitory media), such as a modulated data signal and carrier.

It should be noted that the terms “comprise,” “comprising,” “include,” “including,” etc., or any other variant thereof are intended to cover non-exclusive inclusion, such that a process, method, article or device comprising a set of elements includes not only those elements, but also other elements not expressly listed, or other elements not expressly listed for the purpose of such a process, method, article or device, or elements that are inherent to such process, method, article or device. Without further limitation, an element defined by the phrase “includes a . . . ” does not preclude the existence of additional identical elements in the process, method, article or device that includes the element.

The respective embodiments in the present disclosure are described in a progressive manner, and the same and similar parts between the respective embodiments may be referred to each other. Each embodiment focuses on its differences from other embodiments. In particular, the system embodiments are described simply because they are basically similar to the method embodiments. For relevant details, please refer to the partial description of the method embodiments.

1. A positioning method, comprising:
acquiring a fusion pose of a query frame from a terminal;
acquiring, based on the fusion pose of the query frame, a plurality of candidate pictures from a cloud database, a spatial distance and an angle between each of the plurality of candidate pictures and the query frame meeting a preset condition;
determining, from the plurality of candidate pictures, a top specified number of candidate pictures each having a minimum spatial distance from the query frame as a recall frame; and
determining, based on a matching relationship between feature points of the recall frame and feature points of the query frame, a pose of the query frame to perform positioning according to the pose of the query frame.

2. The positioning method according to claim 1, wherein the acquiring, based on the fusion pose of the query frame, the plurality of candidate pictures from the cloud database, a spatial distance and an angle between each of the plurality of candidate pictures and the query frame meeting the preset condition, comprises:
determining validity of the fusion pose of the query frame based on a calculation result of the fusion pose of the query frame; and
if the fusion pose of the query frame is valid, acquiring, based on the fusion pose of the query frame, from the cloud database, the plurality of candidate pictures from the cloud database, a spatial distance and an angle between each of the plurality of candidate pictures and the query frame meeting the preset condition.

3. The positioning method according to claim 1, wherein the acquiring, based on the fusion pose of the query frame, the plurality of candidate pictures from the cloud database, a spatial distance and an angle between each of the plurality of candidate pictures and the query frame meeting the preset condition, comprises:
determining, in the cloud database, a plurality of pictures each having a spatial distance from the fusion pose less than or equal to a first preset distance threshold; and
acquiring the plurality of candidate pictures from the plurality of pictures, a spatial distance and an angle between each of the plurality of candidate pictures and the query frame meeting the preset condition.

4. The positioning method according to claim 1, wherein the determining, from the plurality of candidate pictures, a top specified number of candidate pictures each having the minimum spatial distance from the query frame as the recall frame, comprises:
sorting the plurality of candidate pictures in an order of spatial distances between the plurality of candidate pictures and the query frame from minimum to maximum; and
determining, from the plurality of candidate pictures after the sorting, a top specified number of candidate pictures each having the minimum spatial distance from the query frame as the recall frame.

5. The positioning method according to claim 4, wherein the determining, based on the matching relationship between feature points of the recall frame and feature points of the query frame, the pose of the query frame to perform positioning according to the pose of the query frame, comprises:
projecting the specified number of feature points of the recall frame onto the query frame, to determine a matching relationship between the specified number of feature points of the recall frame and the feature points of the query frame within a preset range of projection; and
determining, based on the matching relationship between the feature points of the recall frame and the feature points of the query frame, the pose of the query frame to perform positioning according to the pose of the query frame.

6. The positioning method according to claim 1, wherein the determining, based on the matching relationship between feature points of the recall frame and feature points of the query frame, the pose of the query frame to perform positioning according to the pose of the query frame, comprises:
determining feature points matched between the recall frame and the query frame, based on the matching relationship between the feature points of the recall frame and the feature points of the query frame;
determining three-dimensional (3D) points on a map corresponding to the feature points matched between the recall frame and the query frame, wherein feature points in the recall frame have a mapping relationship with the 3D points on the map; and
determining, based on the 3D points on the map corresponding to the feature points matched between the recall frame and the query frame, the pose of the query frame to perform positioning according to the pose of the query frame.

7. The positioning method according to claim 1, wherein the acquiring the fusion pose of the query frame from the terminal comprises:
acquiring a local pose of the query frame on the terminal and a global pose of the query frame on the cloud, from the terminal; and
determining the fusion pose of the query frame based on the local pose of the query frame on the terminal and the global pose of the query frame on the cloud.

8. (canceled)

9. An electronic device, comprising:
a processor; and
a memory, storing computer-executable instructions, wherein the computer-executable instructions, when executed, enable the processor to perform the following operations:
acquiring a fusion pose of a query frame from a terminal;
acquiring, based on the fusion pose of the query frame, a plurality of candidate pictures from a cloud database, a spatial distance and an angle between each of the plurality of candidate pictures and the query frame meeting a preset condition;
determining, from the plurality of candidate pictures, a top specified number of candidate pictures each having a minimum spatial distance from the query frame as a recall frame; and
determining, based on a matching relationship between feature points of the recall frame and feature points of the query frame, a pose of the query frame to perform positioning according to the pose of the query frame.

10. A non-transitory computer-readable storage medium, storing one or more programs, wherein the one or more programs, when executed by an electronic device comprising at least one application program, enable the electronic device to perform the following operations:
acquiring a fusion pose of a query frame from a terminal;
acquiring, based on the fusion pose of the query frame, a plurality of candidate pictures from a cloud database, a spatial distance and an angle between each of the plurality of candidate pictures and the query frame meeting a preset condition;
determining, from the plurality of candidate pictures, a top specified number of candidate pictures each having a minimum spatial distance from the query frame as a recall frame; and
determining, based on a matching relationship between feature points of the recall frame and feature points of the query frame, a pose of the query frame to perform positioning according to the pose of the query frame.

11. The positioning method according to claim 2, wherein the acquiring, based on the fusion pose of the query frame, the plurality of candidate pictures from the cloud database, a spatial distance and an angle between each of the plurality of candidate pictures and the query frame meeting the preset condition, comprises:
determining, in the cloud database, a plurality of pictures each having a spatial distance from the fusion pose less than or equal to a first preset distance threshold; and
acquiring the plurality of candidate pictures from the plurality of pictures, a spatial distance and an angle between each of the plurality of candidate pictures and the query frame meeting the preset condition.

12. The positioning method according to claim 2, wherein the determining, from the plurality of candidate pictures, a top specified number of candidate pictures each having the minimum spatial distance from the query frame as the recall frame, comprises:
sorting the plurality of candidate pictures in an order of spatial distances between the plurality of candidate pictures and the query frame from minimum to maximum; and
determining, from the plurality of candidate pictures after the sorting, a top specified number of candidate pictures each having the minimum spatial distance from the query frame as the recall frame.

13. The positioning method according to claim 3, wherein the determining, from the plurality of candidate pictures, a top specified number of candidate pictures each having the minimum spatial distance from the query frame as the recall frame, comprises:
sorting the plurality of candidate pictures in an order of spatial distances between the plurality of candidate pictures and the query frame from minimum to maximum; and
determining, from the plurality of candidate pictures after the sorting, a top specified number of candidate pictures each having the minimum spatial distance from the query frame as the recall frame.

14. The positioning method according to claim 11, wherein the determining, from the plurality of candidate pictures, a top specified number of candidate pictures each having the minimum spatial distance from the query frame as the recall frame, comprises:
sorting the plurality of candidate pictures in an order of spatial distances between the plurality of candidate pictures and the query frame from minimum to maximum; and
determining, from the plurality of candidate pictures after the sorting, a top specified number of candidate pictures each having the minimum spatial distance from the query frame as the recall frame.

15. The positioning method according to claim 5, wherein the determining, based on the matching relationship between feature points of the recall frame and feature points of the query frame, the pose of the query frame to perform positioning according to the pose of the query frame, comprises:
determining feature points matched between the recall frame and the query frame, based on the matching relationship between the feature points of the recall frame and the feature points of the query frame;
determining three-dimensional (3D) points on a map corresponding to the feature points matched between the recall frame and the query frame, wherein feature points in the recall frame have a mapping relationship with the 3D points on the map; and
determining, based on the 3D points on the map corresponding to the feature points matched between the recall frame and the query frame, the pose of the query frame to perform positioning according to the pose of the query frame.

16. The positioning method according to claim 2, wherein the acquiring the fusion pose of the query frame from the terminal comprises:
acquiring a local pose of the query frame on the terminal and a global pose of the query frame on the cloud, from the terminal; and
determining the fusion pose of the query frame based on the local pose of the query frame on the terminal and the global pose of the query frame on the cloud.

17. The positioning method according to claim 3, wherein the acquiring the fusion pose of the query frame from the terminal comprises:
acquiring a local pose of the query frame on the terminal and a global pose of the query frame on the cloud, from the terminal; and
determining the fusion pose of the query frame based on the local pose of the query frame on the terminal and the global pose of the query frame on the cloud.

18. The positioning method according to claim 4, wherein the acquiring the fusion pose of the query frame from the terminal comprises:
acquiring a local pose of the query frame on the terminal and a global pose of the query frame on the cloud, from the terminal; and
determining the fusion pose of the query frame based on the local pose of the query frame on the terminal and the global pose of the query frame on the cloud.

19. The positioning method according to claim 5, wherein the acquiring the fusion pose of the query frame from the terminal comprises:
acquiring a local pose of the query frame on the terminal and a global pose of the query frame on the cloud, from the terminal; and
determining the fusion pose of the query frame based on the local pose of the query frame on the terminal and the global pose of the query frame on the cloud.

20. The positioning method according to claim 6, wherein the acquiring the fusion pose of the query frame from the terminal comprises:
acquiring a local pose of the query frame on the terminal and a global pose of the query frame on the cloud, from the terminal; and
determining the fusion pose of the query frame based on the local pose of the query frame on the terminal and the global pose of the query frame on the cloud.

21. The electronic device according to claim 9, wherein the acquiring, based on the fusion pose of the query frame, the plurality of candidate pictures from the cloud database, a spatial distance and an angle between each of the plurality of candidate pictures and the query frame meeting the preset condition, comprises:
determining validity of the fusion pose of the query frame based on a calculation result of the fusion pose of the query frame; and
if the fusion pose of the query frame is valid, acquiring, based on the fusion pose of the query frame, from the cloud database, the plurality of candidate pictures from the cloud database, a spatial distance and an angle between each of the plurality of candidate pictures and the query frame meeting the preset condition.
